(19) United States
(12) Patent Application Publication
(10) Pub. No.: US 2002/0138368 A1
(43) Pub. Date: Sep. 26, 2002

(54) Network-based method and system for configuring air circuit breakers

(76) Inventors: Rajesh Pandey, Delhi (IN); Philip Thomas Williams, Formby (GB); Dave James McWilliam, Liverpool (GB)

Correspondence Address: John S.Beulick, Armstrong Teasdale LLP, Suite 2600, One Metropolitan Sq., St. Louis, MO, 63102, US

(21) Appl. No.: 09/812,600

(22) Filed: Mar. 20, 2001

(51) Int. Cl. G06F 17/60

(52) U.S. Cl. 705/27

(57) ABSTRACT

A network-based method for configuring air circuit breakers includes receiving air circuit breaker specification information from a user and using a server to compare the received specification information with pre-stored information. The method also includes selecting at least one air circuit breaker that matches the received specification information and displaying to the user information related to the air circuit breaker. A network-based method also provides for selection of a various accessories for the selected air circuit breaker.

### BACKGROUND OF THE INVENTION

This invention relates generally to computer network-based systems and more particularly to a network-based method and system for configuring air circuit breakers.

Air circuit breakers are used in electric equipment and machinery, but identifying a correct air circuit breaker for a specific application is not always an easy task. Many parameters should be considered, and each combination of parameters could demand a specific product for optimum performance.

Therefore, it would be desirable to quickly determine a proper product that should be used for different combinations of parameters. In addition, it would be desirable to determine if a particular product provides inadequate performance for equipment, machinery, or a facility.

### BRIEF SUMMARY OF THE INVENTION

In an exemplary embodiment, an air circuit breaker selection system allows users to select the most appropriate air circuit breaker for their application needs over the Internet. The system guides a web user to answer several pre-arranged questions interactively about the product attributes and then uses those inputs to direct the user to a uniquely configured product having a specific catalog number. If the user's input combination results in an invalid configuration, the user receives messaging to guide the user to a valid alternative. The system allows both experienced and novice users to place orders directly for air circuit breakers through use of the Internet.

The network-based method for selecting a correct air circuit breaker includes receiving product specification information from a user and comparing the received product specification information with pre-stored air circuit breaker information. If pre-stored product information for at least one air circuit breaker matches the received user criteria for the desired air circuit breaker, the pre-stored air circuit breaker information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF THE DRAWINGS

FIG. 1 is a block diagram of a system in accordance with one embodiment of the present invention.

FIG. 2 is an expanded version block diagram of an exemplary embodiment of a server architecture of an alternative system.

FIG. 3 is a flow diagram of a network-based method for configuring air circuit breakers.

FIG. 4 is an exemplary embodiment of an air circuit breaker configuration page.

FIG. 5 is an exemplary embodiment of an air circuit breaker —Configure the Protection Relay+Options for Relay page.

FIG. 6 is an exemplary embodiment of an air circuit breaker —Configure the Electrical Accessories page.

FIG. 7 is an exemplary embodiment of an air circuit breaker —Configure the Mechanical Accessories page.

FIG. 8 is an exemplary embodiment of an air circuit breaker —Help page.

FIG. 9 is an exemplary embodiment of an air circuit breaker —exception message page.

FIG. 10 is an exemplary embodiment of an air circuit breaker—Bill of Material page.

### DETAILED DESCRIPTION OF THE INVENTION

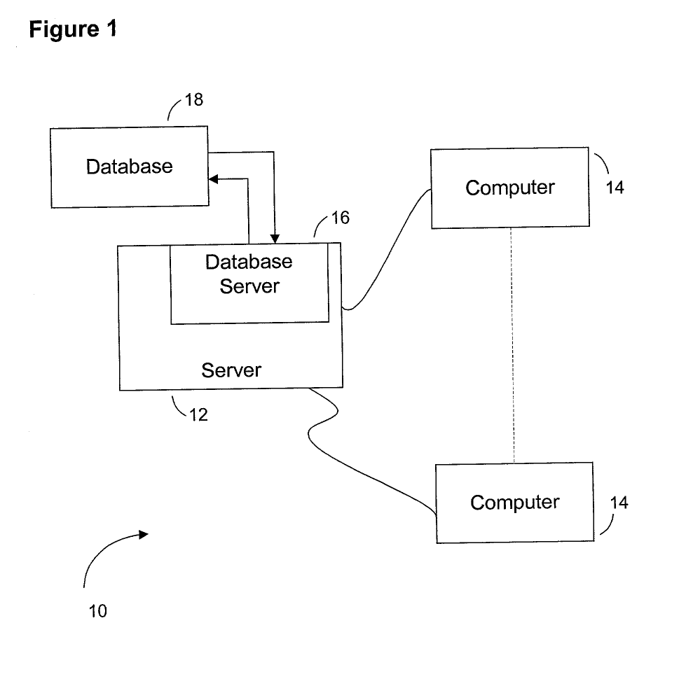

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing air circuit breaker information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

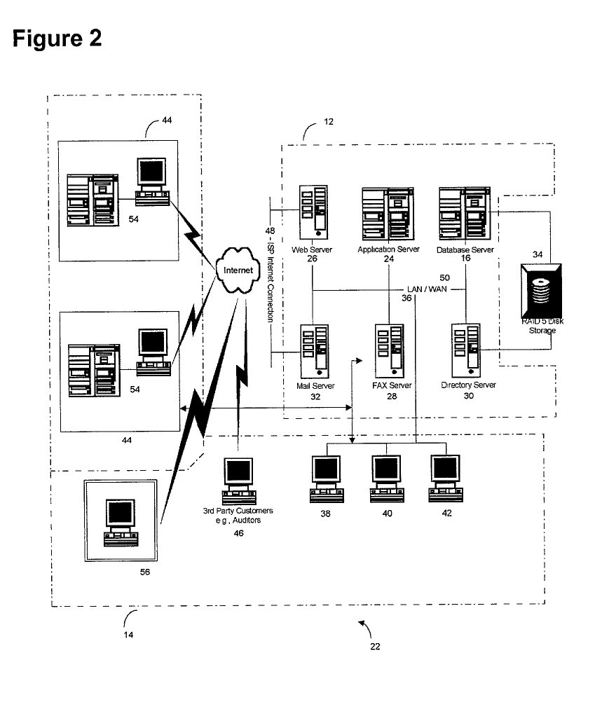

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 54 can access server sub-system 12. One of user devices 14 includes a workstation 54 located at a remote location. Workstations 54 are personal computers having a web browser. Also, workstations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

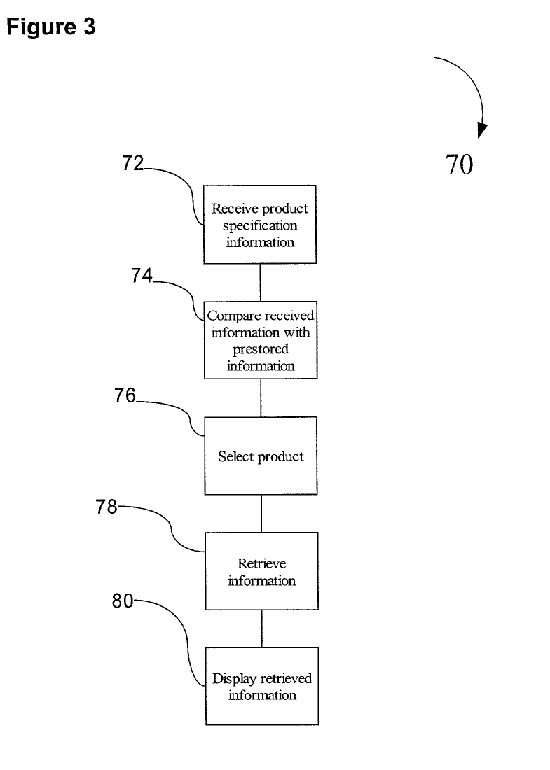

FIG. 3 is a flow diagram 70 for a network-based method for configuring air circuit breakers. In one embodiment, the air circuit breaker selection involves selection of air circuit breakers. System 10 (shown in FIG. 1) receives 72 product specification information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 74 the received air circuit breaker related requirements to pre-stored information accessible by server 12. In one embodiment, the pre-stored information is stored in a database that resides on server 12. In an alternative embodiment, the pre-stored information is stored in a database remote from server 12. The pre-stored information includes various types and configurations of air circuit breaker related information. Server 12 compares the user provided information to the pre-stored information to determine if any pre-stored air circuit breaker information contained in the database satisfy the product specifications/requirements submitted by the user.

In addition, server system 12 assesses the information supplied by the user to validate configuration compatibility of the product. Exemplary information includes product application, product parameters, desired product features, and product accessories. System 10 evaluates the information supplied by the user and determines whether a resulting product incorporating an air circuit breaker having the received product specifications is capable of meeting parameters of the indicated product. For example, system 10 determines whether a selected air circuit breaker with a given requirement is available to satisfy the user, and, if the selected air circuit breaker with a given requirement is not available, system 10 displays a message to the user that the air circuit breaker with the required product characteristics is not available and that the user should select an alternative product. In summary, system 10 reviews the user input and based on a pre-determined air circuit breaker configuration as well as operating specifications, the user is provided feedback for a specific air circuit breaker that meets the criteria for the user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored air circuit breaker information that matches the information entered by the user and selects 76 air circuit breaker configurations from the pre-stored information. System 10 retrieves 78 information pertaining to the selected air circuit breaker configuration. In one embodiment, the air circuit breaker information includes an air circuit breaker identifier number and associated price for each selected air circuit breaker configuration. For example, the air circuit breaker identifier number is a catalog number and the price is a list price of the product. Server 12 then transmits the retrieved identifier number and associated price and downloads the retrieved air circuit breaker information to user device 14 for display 80 so that the user can view the information. In an alternative embodiment, system 10 uses the list price information to generate a quotation for each selected air circuit breaker configuration including the indicated features and accessories and server 12 then transmits the retrieved air circuit breaker identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

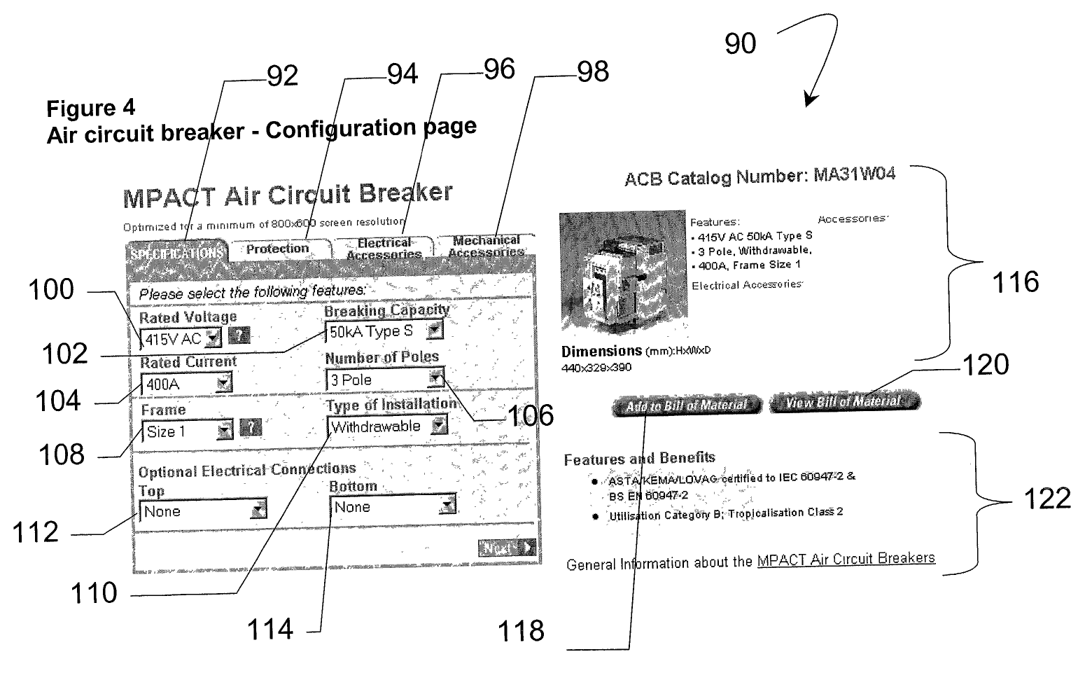

FIG. 4 is an exemplary embodiment of an air circuit breaker configuration page, as depicted screen shot 90. Screen shot 90 includes a Specifications tab 92, a Protection tab 94, an Electrical Accessories tab 96, and a Mechanical Accessories tab 98. Selection of Specifications tab 92 results in screen shot 90, which includes a Rated Voltage pull down menu and help button 100, a Breaking Capacity pull down menu 102, a Rated Current pull down menu 104, a Number of Poles pull down menu 106, a Frame pull down menu 108, a Type of Installation pull down menu 110, an Optional Electrical Connections—Top pull down menu 112, and an Optional Electrical Connections—Bottom pull down menu 114. Screen shot 90 also includes a product information display area 116, that in one embodiment includes a catalog number, an Add To Bill Of Material button 118, a View Bill Of Material button 120, and a Features And Benefits display area 122.

Selection of Add to Bill of Material button 118 adds the selected item to the bill of material. View Bill of Material button 120 causes system 10 (shown in FIG. 1) to display a Bill of Material page, discussed below.

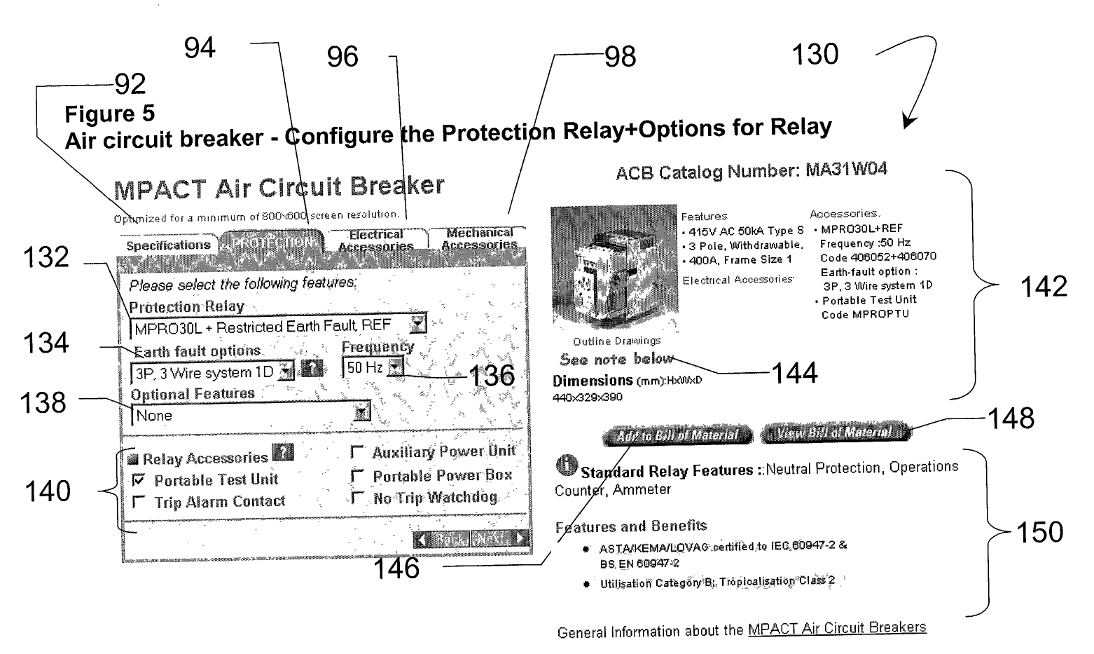

FIG. 5 is an exemplary embodiment of an air circuit breaker —configure the protection relay and options for relay page, as depicted screen shot 130. Screen shot 130 results from selection of Protection Tab 94 (shown in FIG. 4), and includes a Protection Relay pull down menu 132, an Earth Fault Options pull down menu and help button 134, a Frequency pull down menu 136, an Optional Features pull down menu 138, and Relay Accessories checkboxes and help button 140 for specifying a Portable Test Unit, a Trip Alarm Contact, an Auxiliary Power Unit, a Portable Power Box, and a No Trip Watchdog and for requesting help regarding each item. Screen shot 130 also includes a product information display area 142, that in one embodiment includes a catalog number and a flashing message 144 to attract attention to any advisory message, an Add To Bill Of Material button 146, a View Bill Of Material button 148, and a Features and Benefits display area 150, that in one embodiment includes an advisory message.

Selection of Add to Bill of Material button 146 adds the selected item to the bill of material. View Bill of Material button 148 causes system 10 (shown in FIG. 1) to display a Bill of Material page, discussed below.

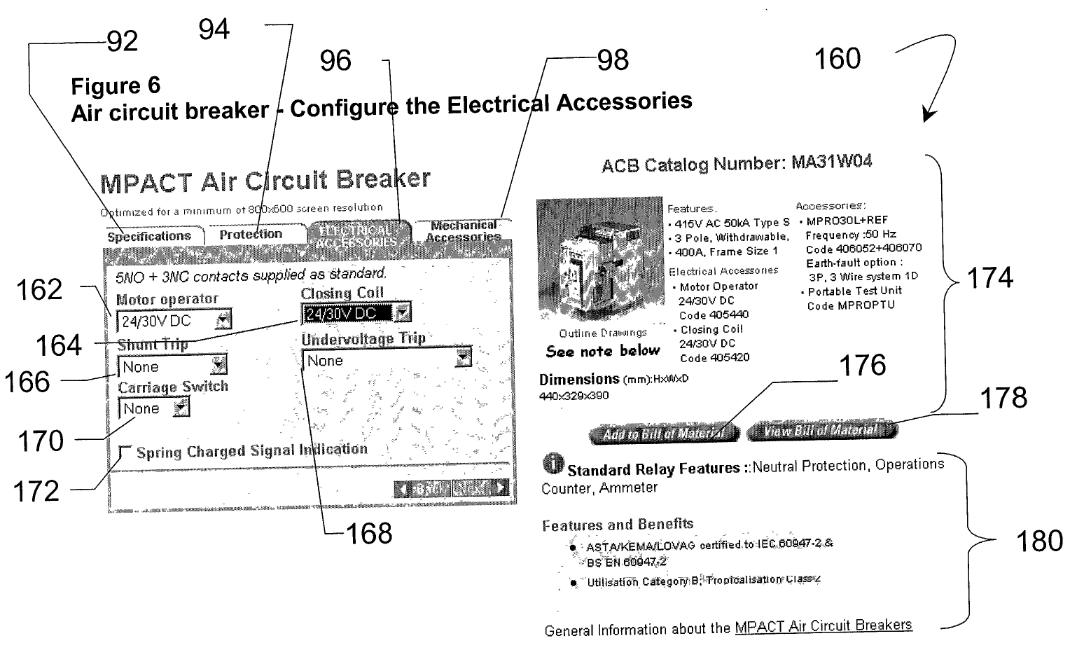

FIG. 6 is an exemplary embodiment of air circuit breaker—configure the electrical accessories page, as depicted screen shot 160. Screen Shot 160 results from selection of Electrical Accessories tab 96 (shown in FIG. 4), and includes a Motor Operator pull down menu 162, a Closing Coil pull down menu 164, a Shunt Trip pull down menu 166, an Under voltage Trip pull down menu 168 and a set of checkboxes 170 for specifying a Carriage Switch pull down menu 170 and a Springs Charged Signal Indication 172. Screen shot 160 also includes a product information display area 174, that in one embodiment includes a catalog number, an Add To Bill Of Material button 176, a View Bill Of Material button 178, and a Features And Benefits display area 180.

Selection of Add to Bill of Material button 176 adds the selected item to the bill of material. View Bill of Material button 178 causes system 10 (shown in FIG. 1) to display a Bill of Material page, discussed below.

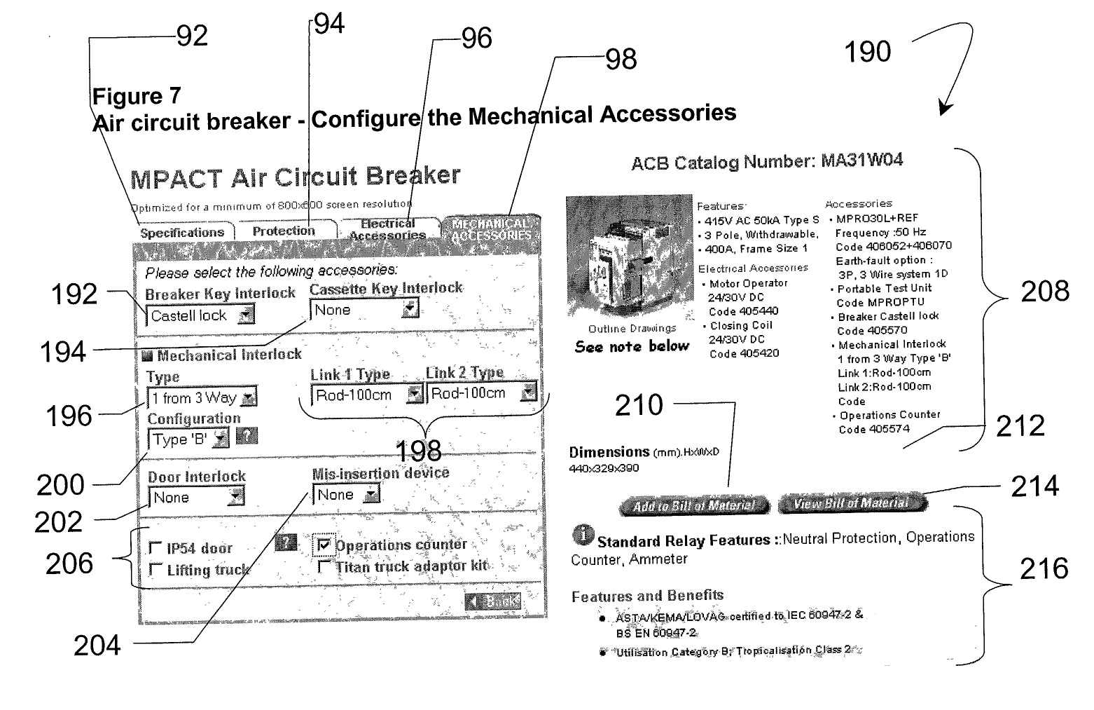

FIG. 7 shows an exemplary embodiment of air circuit breaker—configure the mechanical accessories page, as depicted screen shot 190. Screen shot 190 results from selection of Mechanical Accessories tab 98 (shown in FIG. 4), and includes a Breaker Key Interlock pull down menu 192, a Cassette Key Interlock pull down menu 194, a Mechanical Interlock Type pull down menu 196, a pair of Mechanical Interlock Link 1 Type and Link 2 Type pull down menus 198, a Mechanical Interlock Configuration pull down menu and help button 200, a Door Interlock pull down menu 202, a Mis-Insertion Device pull down menu 204, and a set of checkboxes and a help button 206 for specifying an IP54 Door, a Lifting Truck, an Operations Counter, and a Titan Truck Adapter Kit and for obtaining help regarding these items. Screen shot 190 also includes a product information display area 208, that in one embodiment includes a catalog number, an Add To Bill Of Material button 210, a View Bill Of Material button 214, and a Features and Benefits display area 216.

Selection of Add to Bill of Material button 210 adds the selected item to the bill of material. View Bill of Material button 212 causes system 10 (shown in FIG. 1) to display a Bill of Material page, discussed below.

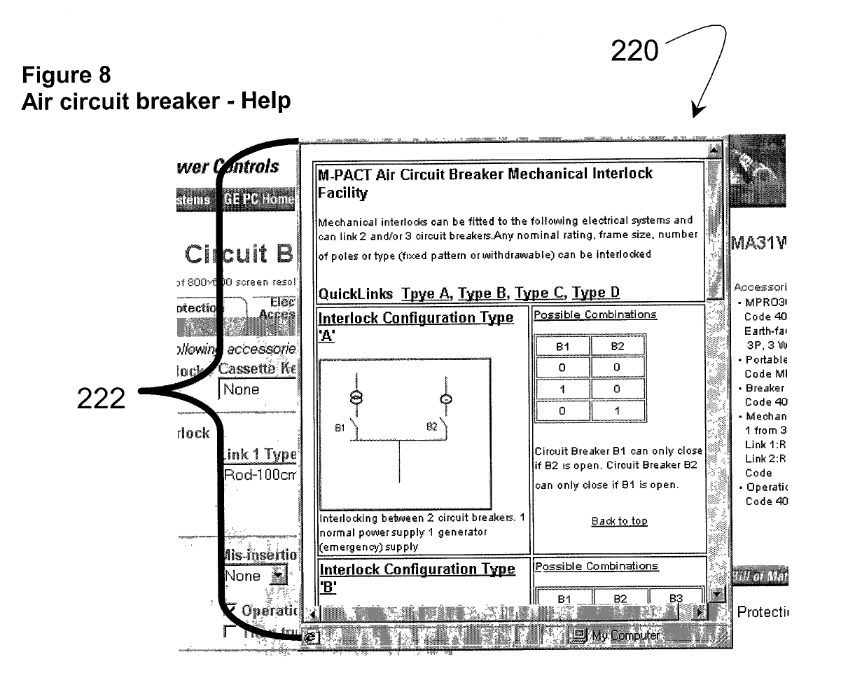

FIG. 8 is an exemplary embodiment of an air circuit breaker —help page, as depicted screen shot 220. Screen shot 220 includes a help display area 222 that results from selection of the help button in Mechanical Interlock Configuration pull down menu and help button 200 (shown in FIG. 7). Help display area 222 in one embodiment includes information about an air circuit breaker mechanical interlock facility that informs the user about selection and usage of mechanical interlock facilities for an air circuit breaker.

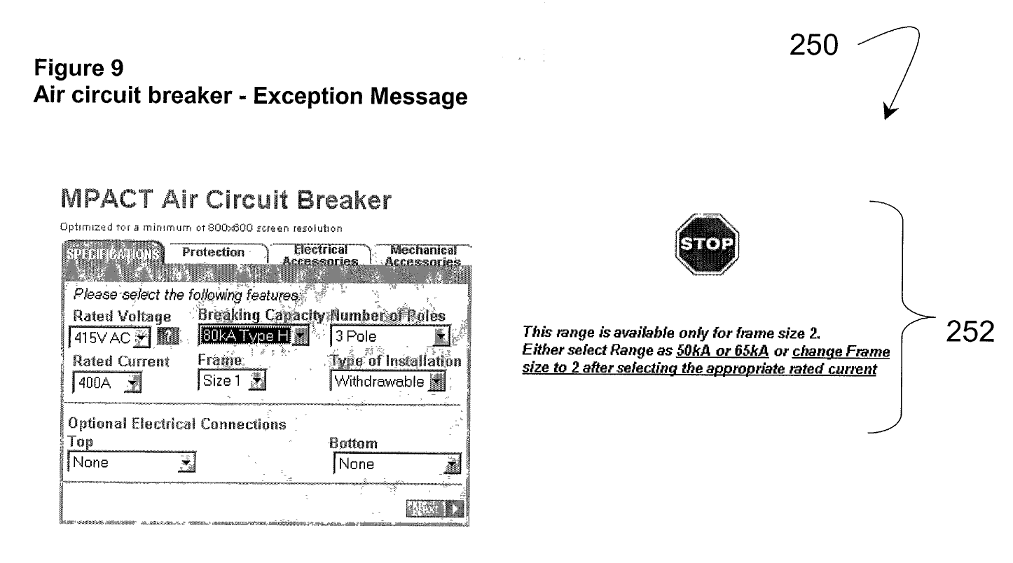

FIG. 9 is an exemplary embodiment of air circuit breaker exception message page, as depicted screen shot 250, which includes an exception message display area 252 that informs the user that an air circuit breaker with mutually incompatible features has been selected, and how to correct the selection.

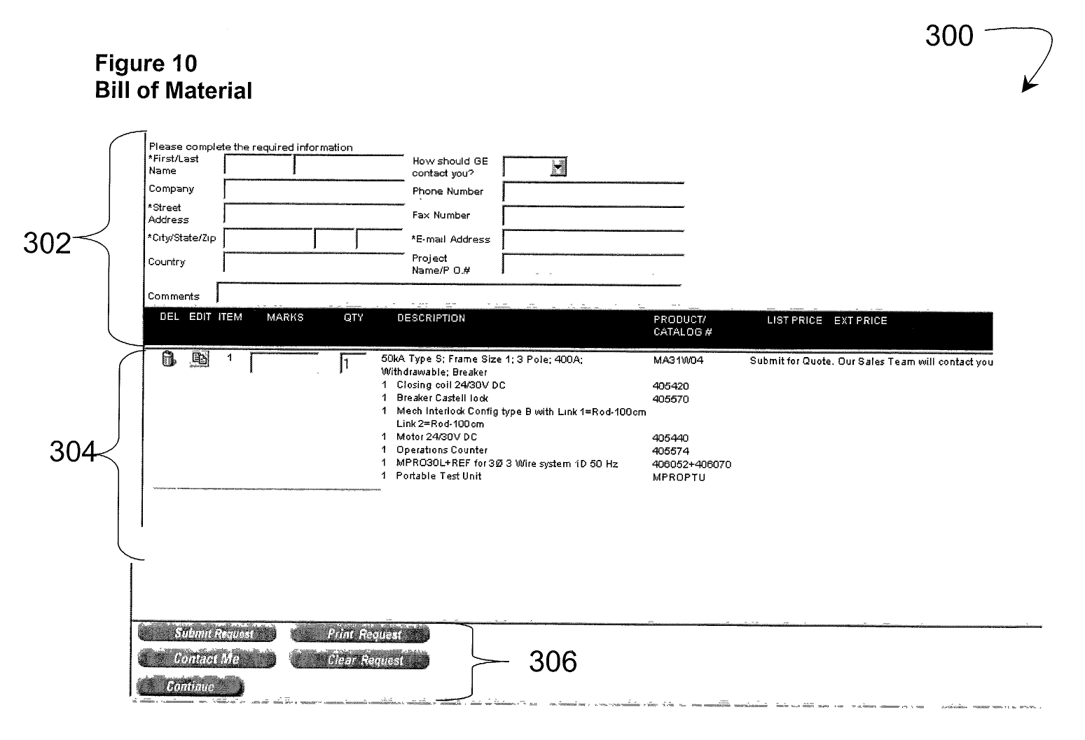

FIG. 10 is an exemplary embodiment of a Bill of Material page, as depicted in screen shot 300, that is downloaded and displayed by server system 12 when the user has selected a “View Bill of Material” button in one of FIGS. 4 through 7. Screen shot 300 includes a customer information area 302 where a user can specify contact information. Screen shot 300 also includes an order area 304 to display information about the order, including in one embodiment a specification of an item ordered, the quantity, description, catalog number, and price. Screen shot 300 further includes a set of radio buttons 306 that allow the user to submit the order, print the order, clear the bill of material, request that the user be contacted, find out where to buy the product, or continue.

In use, system 10 (shown in FIG. 1) provides the user with a complete air circuit breaker configured to meet the user's needs. The user selects the rating of the air circuit breaker, including voltage rating, breaking capacity, rated current, and any optional features. Based on these inputs system 10 displays the individual equipment prices and the total list price of the individual components. System 10 does not allow the user to configure a selection that is invalid and guides the user by informing the user why the selected configuration is invalid. Once the customer has configured the product, the user can add it to the user's bill of materials and then view the bill of materials, which the user can optionally print, or submit as an order.

While the invention has been described in terms of various specific embodiments, those skilled in the art will recognize that the invention can be practiced with modification within the spirit and scope of the claims.

What is claimed is:

1. A method for facilitating selection of an air circuit breaker through use of a network-based system including a server and at least one device connected to the server via a network, said method comprising the steps of:
receiving product specification information from a user via the device;
comparing the received product specification information with pre-stored air circuit breaker information;
selecting at least one air circuit breaker that matches the received product specification information; and
displaying the information related to the air circuit breaker.

2. A method according to claim 1 wherein said step of comparing the received product specification information comprises the steps of:
determining whether the features selected are available for the selected air circuit breaker configuration; and
displaying a message if the selected features are not available for the selected air circuit breaker configuration.

3. A method according to claim 1 wherein said step of receiving product information data from a user further comprises the step of receiving an identification for the product.

4. A method according to claim 1 wherein said step of displaying information related to the air circuit breaker comprises the step of displaying the features selected for the air circuit breaker

5. A method according to claim 1 wherein said step of displaying information related to the air circuit breaker comprises the step of displaying the accessories selected for the air circuit breaker.

6. A method according to claim 1 wherein said step of displaying information related to the air circuit breaker comprises the step of displaying a catalog number and a list price for the air circuit breaker.

7. A method according to claim 1 wherein said step of displaying information further comprises the step of generating a quotation for the air circuit breaker.

8. A method according to claim 1 wherein said step of displaying information related to the air circuit breaker comprises the step of displaying the dimensions of the air circuit breaker.

9. A method according to claim 1 wherein the product specification information is received from the user via a graphical user interface.

10. A method according to claim 1 further comprising the step of assessing a need of the user based on at least one of a product application, product parameters, desired product features, and product accessories.

11. A method according to claim 1 further comprising the step of validating configuration compatibility based on the received product specification information to determine whether a resulting air circuit breaker having the received product specifications is capable of meeting parameters of the product.

12. A method according to claim 11 further comprising the step of guiding the user, if the resulting product does not meet the parameters of the product, to a correct product configuration.

13. A method according to claim 11 further comprising the step of guiding the user to a compatible product.

14. A system for facilitating selection of an air circuit breaker, said system comprising:
a device; and
a server connected to said device and configured to receive product specification information data from a user via said device, said server further configured to:
compare the received product specification information with pre-stored air circuit breaker information;
select at least one air circuit breaker from the pre-stored air circuit breaker information based on air circuit breaker identification criteria entered by the user; and
display information related to the air circuit breaker based on the air circuit breaker identification criteria.

15. A system according to claim 14 wherein said server further configured to download to the user the information related to the air circuit breaker.

16. A system according to claim 14 wherein said server further configured to:
determine whether the features selected are available for the selected air circuit breaker configuration; and
display a message if the selected features are not available for the selected air circuit breaker configuration.

17. A system according to claim 14 wherein said server further configured to receive an identification for the product.

18. A system according to claim 14 wherein said server further configured to display the dimensions of the air circuit breaker.

19. A system according to claim 14 wherein said server further configured to display the accessories selected for the air circuit breaker.

20. A system according to claim 14 wherein said server further configured to:
determine whether the features selected are available for the selected air circuit breaker configuration; and
display a message if the selected features are not available for the selected air circuit breaker configuration.

21. A system according to claim 14 wherein said server further configured to receive an identification for the product.

22. A system according to claim 14 wherein said server further configured to display the features selected for the air circuit breaker.

23. A system according to claim 14 wherein said server further configured to display the dimensions of the air circuit breaker.

24. A system according to claim 14 wherein said server further configured to display the accessories selected for the air circuit breaker.

25. A system according to claim 14 wherein said server further configured to display a catalog number and a list price for the air circuit breaker.

26. A system according to claim 14 wherein said server further configured to generate a quotation for the air circuit breaker.

27. A system according to claim 14 wherein said server further configured to receive the product specification information from the user via a graphical user interface.

28. A system according to claim 14 wherein said server further configured to assess a need of the user based on at least one of a product application, product parameters, desired product features, and product accessories.

29. A system according to claim 28 wherein said server further configured to validate configuration compatibility based on the received product specification information to determine whether a resulting air circuit breaker having the received product specifications is capable of meeting parameters of the product.

30. A system according to claim 29 wherein said server further configured to guide the user, if the resulting product does not meet the parameters of the product, to a correct product configuration.

31. A system according to claim 30 wherein said server further configured to guide the user to a compatible product.

32. A system according to claim 14 wherein said server further configured to accept a purchase order for the air circuit breaker after the purchase order has been authenticated against predetermined criteria.

33. A system according to claim 14 wherein said device configured to be a server for a network of customer devices.

34. A system according to claim 14 wherein said server and said device are connected via a network.

35. A system according to claim 34 wherein said network is one of a wide area network, a local area network and the Internet.
